(19) United States
(12) Patent Application Publication
(10) Pub. No.: US 2007/0215777 A1
(43) Pub. Date: Sep. 20, 2007

(54) Telescopic monitor support post

(76) Inventor: Andrew Mills, London (GB)

Correspondence Address: CARTER, DELUCA, FARRELL & SCHMIDT, LLP, 445 BROAD HOLLOW ROAD, SUITE 225, MELVILLE, NY, 11747, US

(21) Appl. No.: 11/636,212

(22) Filed: Dec. 8, 2006

(30) Foreign Application Priority Data
Dec. 8, 2005 (GB) GB0525010.5

(51) Int. Cl. F16M 11/00

(52) U.S. Cl. 248/414; 384/49; 248/917

(57) ABSTRACT

A telescopic monitor support post is disclosed. It comprises a shaft and a sleeve slideable over the shaft against the force provided by a gas strut mounted within and extending between the shaft and the sleeve. A bearing slide assembly is disposed between the shaft and the sleeve and is configured to slide relative to both the shaft and the sleeve during movement of the sleeve relative to the shaft.

### CROSS-REFERENCE TO RELATED APPLICATIONS

The present application claims the benefit of and priority to United Kingdom Application Serial No. GB0525010.5, filed on Dec. 8, 2005, the entire contents of each of which are incorporated herein by reference.

The present invention relates to a telescopic monitor support post to enable a monitor carried by the support post to be adjusted in height. More specifically, it relates to a support post for a flat-screen display for use with a computer monitor.

A telescopic monitor support post that has means to enable the height of the monitor to be adjusted to suit a particular user is well known. However, many telescopic monitor support posts are not particularly easy to use because, in order to adjust the height of the monitor, the user must release a clamp or other fastener so that they bear the whole weight of the monitor in their hands. They must then carefully raise or lower the monitor relative to the post into the desired position and retighten the clamp to hold it in place. Accurate adjustment is therefore difficult and often requires the use of one or more tools to release and/or tighten the clamping mechanism.

The disadvantages associated with the type of monitor support post mentioned above has more recently been alleviated by the provision of a monitor support post incorporating a gas strut to support the weight of the monitor at any height within a specified range of movement. This type of monitor support post generally comprises a shaft which is attached to, and upstands from, a desk, workstation or other supporting surface and, a sleeve to which the monitor is coupled. The sleeve extends over the shaft and is slideable relative to the shaft. A bearing is mounted to the sleeve or to the shaft so that the sleeve will slide relative to the shaft smoothly and with minimum friction. The gas strut is selected in dependence on the weight of the monitor to be supported so that the weight of the monitor is counterbalanced by the load provided by the gas strut and no clamping mechanism is required. The sleeve can therefore slide relative to each other to move the screen into the desired position without having to release a clamp and carry the entire weight of the monitor during adjustment.

Despite the advantages provided by the use of telescopic monitor support posts incorporating gas struts, they do still suffer from some disadvantages. In particular, if the monitor is attached to the end of a support arm which is in turn attached to a monitor support post incorporating the gas strut, the screen and therefore a significant part of the weight that must be carried by the monitor support post is located a considerable distance away from it. This places considerable stress on the bearing causing premature failure or, at the very least, making it very difficult to slide the sleeve relative to the shaft due to the offset load, unless the monitor and/or the support arm and monitor are detached from the monitor support post to remove the weight carried by the post before any adjustment is made. However, even if relative motion between the sleeve and shaft can be achieved with the monitor and support arm in position, the movement often lacks smoothness, which is undesirable and significantly lowers the products appeal to a consumer.

The present invention seeks to overcome or substantially alleviate the problems with conventional monitor support posts some of which have been described above.

### SUMMARY

According to the present invention, there is provided a telescopic monitor support post comprising a shaft and a sleeve slideable over the shaft against a load provided by a gas strut mounted within and extending between the shaft and the sleeve, wherein a bearing slide assembly is disposed between the shaft and the sleeve and slides relative to both the shaft and the sleeve during movement of the sleeve relative to the shaft.

Preferably, an outer surface of the shaft and inner surface of the sleeve comprise bearing surfaces, the bearing slide assembly cooperating with said bearing surfaces during movement of the sleeve relative to the shaft.

In a preferred embodiment, the bearing slide assembly comprises a bearing carriage member having a plurality of individually spaced pockets, each pocket being adapted to receive and rotatably capture a bearing therein so that a portion of the bearing protrudes from either side of the bearing carriage member for cooperation with the bearing surfaces of the shaft and sleeve.

The bearing carriage member is preferably formed from a sheet of flexible material which is shaped to fit within the space between the shaft and the sleeve.

The sheet may comprise separate groups of pockets, each group being spaced from an adjacent group in a direction of movement of the sleeve relative to the shaft.

In a preferred embodiment, the pockets of each group are separated from each other in a direction substantially at right angles to the direction of movement of the sleeve relative to the shaft.

The sleeve and shaft may have a circular cross section and the pockets of each group are separated from each other in a circumferential direction.

Advantageously, the pockets of each group are separated from each other by a region of reduced wall thickness to increase the flexibility of the bearing carriage member in said region relative to the remainder of the bearing carriage member.

Each group of pockets is preferably joined by elongate joining portions with spaces therebetween.

In one sleeve includes a longitudinally extending protrusion upstanding from its bearing surface towards the shaft and the shaft has a cooperating member thereon which slideably cooperates with the protrusion to prevent the shaft from rotating relative to the sleeve.

In one embodiment, the bearing carriage member has longitudinal edges which are brought towards each other when shaped to locate it between the shaft and the sleeve, the protrusion on the sleeve locating between said edges when the bearing carnage member is located between the shaft and the sleeve.

In a preferred embodiment the telescopic monitor support post comprising a friction adjustment mechanism to enable a user to control the degree of friction between the shaft and the sleeve.

The friction adjustment mechanism may comprise a flexible collar mounted on an end of the sleeve having a plurality of spaced friction surfaces for engagement with the bearing surface of the shaft.

The collar preferably has a break to form two facing end surfaces with a friction control member extending therethrough to control the pressure of the friction surfaces against the bearing surface of the shaft.

The friction control member may comprise a captive bolt extending through the facing end surfaces which carries a spring and a nut, the nut being rotatable relative to the bolt to change the tension in the spring and thereby control pressure applied to the bearing surface of the shaft by the friction surfaces.

The monitor support post preferably includes a locking ring to attach the collar to the sleeve, the collar comprising a pair of resiliently flexible downwardly extending arms that pass through the collar, each arm having a laterally extending lug on its free end which engages in a corresponding opening in the sleeve.

In one embodiment, a support arm for supporting a monitor may be slideably received on the sleeve and the monitor support post comprises a lockable clamping ring which is slideable on the sleeve when released to enable the height of a support arm to be adjusted relative to the sleeve in addition to enabling movement of the sleeve relative the shaft.

### DETAILED DESCRIPTION OF THE DRAWINGS

An embodiment of the invention will now be described, by way of example only, and with reference to the accompanying drawings, in which:

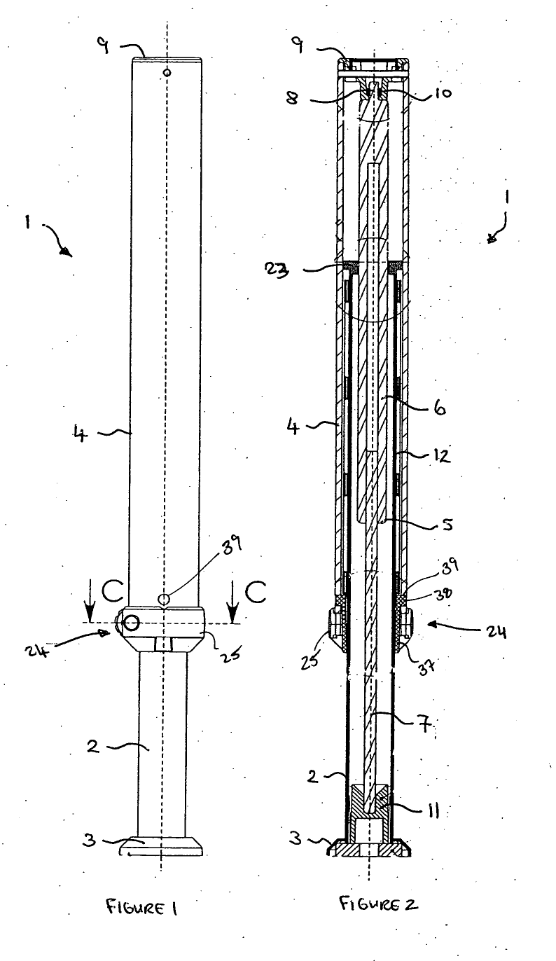

FIG. 1 shows a side view of a monitor support post according to an embodiment of the present invention;

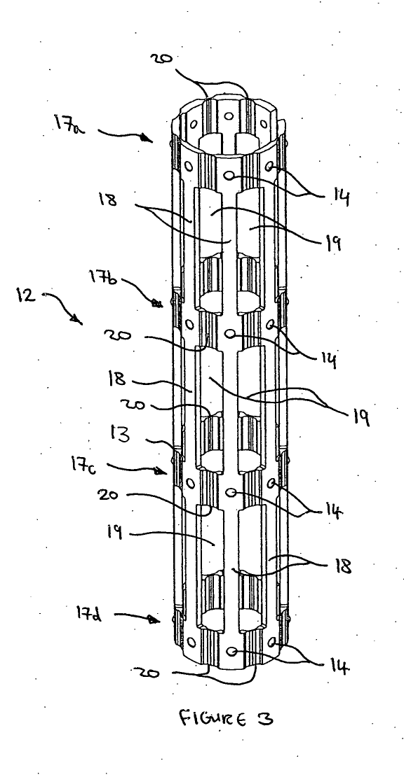

FIG. 2 shows a side sectional view of a monitor support post as shown in FIG. 1;

FIG. 3 is a perspective view of the bearing slide assembly in its deformed state;

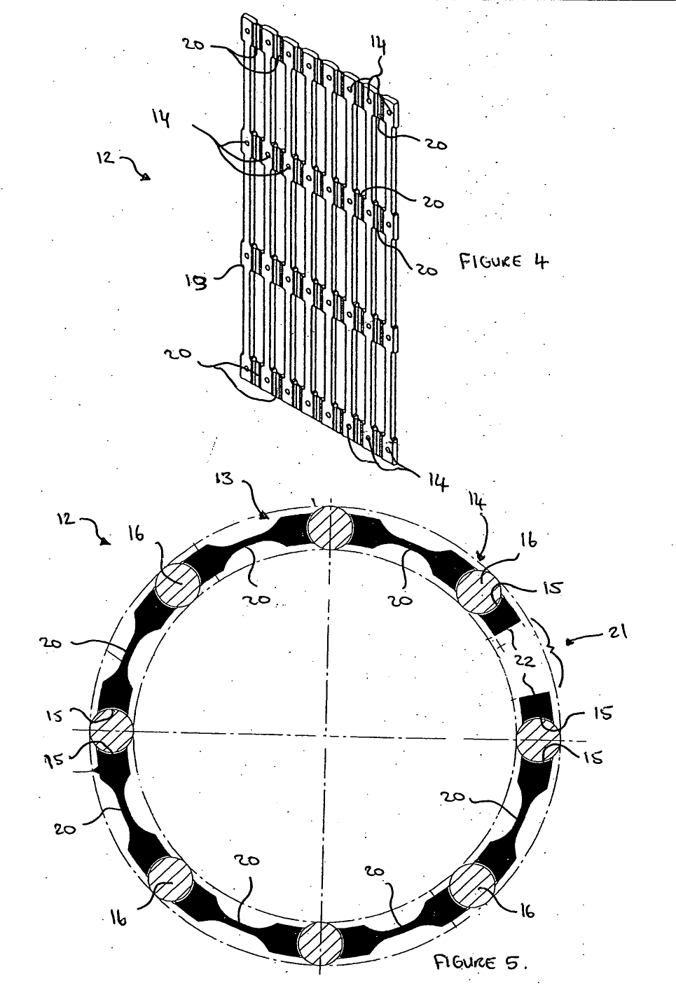

FIG. 4 is a perspective view of the bearing slide assembly as a flat sheet and before being folded into the tubular shape shown in FIG. 3;

FIG. 5 is a top plan view of the bearing slide assembly shown in FIGS. 3 and 4;

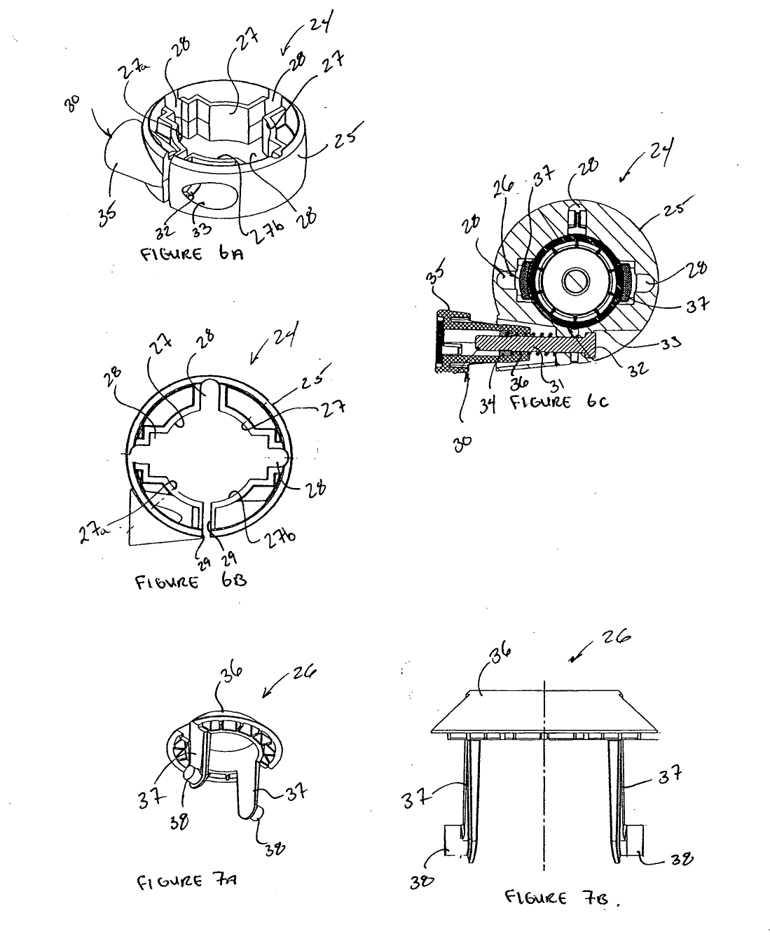

FIG. 6A shows a perspective view of a collar forming part of the friction adjustment mechanism;

FIG. 6B shows a top plan view of the collar shown in FIG. 6A;

FIG. 6C shows a sectional top plan view through the assembled friction adjustment mechanism, shaft and sleeve;

FIG. 7A shows a perspective view of the collar locking ring; and

FIG. 7B shows a front view of the collar locking ring shown in FIG. 7A.

### DETAILED DESCRIPTION OF EMBODIMENTS

Referring now to the drawings, there is shown in FIG. 1, a monitor support post 1 according to the present invention comprising a shaft 2 having a lower end 3 for attachment to the upper surface of a desk or workstation on which the monitor is to be placed so that it upstands in a vertical direction. A desk clamp (not shown) may be used for the purpose of attaching the shaft 2 to the desk.

A sleeve 4 is slideably received over the upper free end of the shaft 2. As can be seen from FIG. 2, a gas strut 5 having a cylinder 6 and a piston 7 is located within and extends between the shaft 2 and the sleeve 4. The cylinder 6 has a short threaded rod 8 protruding from its upper end which passes through a retaining cap 9 attached to the upper end of the sleeve 4. A nut 10 is screwed onto the threaded rod 8 to attach the cylinder 6 to the retaining cap 9. Likewise, the free end of the piston 7 is coupled to a bottom plug 11 mounted on the end of the shaft 2. It will therefore be appreciated that the gas strut 5 is compressed when the sleeve 4 is slid further over the shaft 2. If no monitor is carried by the post 1, compression of the gas strut 5 forces the sleeve 4 back to its original position when released. However, when a monitor is present, the force generated by compression of the strut 5 is counterbalanced by the weight of the monitor and so the sleeve 4 can be slid relative to the shaft 2 and retained in that position when released.

A bearing slide assembly 12 is disposed in a space between the shaft 2 and the sleeve 4. The bearing slide assembly 12 is a discrete component and is entirely separate and detached from both the sleeve 4 and shaft 2 so that it can slide relative to both of them during movement of the sleeve 4 relative to the shaft 2. The bearing slide assembly 12 is illustrated in FIGS. 3 to 5 and comprises a bearing carriage 13 formed from a flexible plastics material. The bearing carriage 13 is initially moulded as a flat rectangular sheet of material, as shown in FIG. 4, which is subsequently shaped into its final tubular form, as shown in FIG. 3. The bearing carriage 13 comprises a plurality of pockets or bearing seats 14 each of which have arcuate wall surfaces 15 that capture and rotatably mount a ball bearing 16 therein. The diameter of the bearings 16 is greater than the thickness of the pockets 14 so that the bearings 16 protrude from either side of the bearing carriage 13 and so that the bearings 16 cooperate with the outer surface of the shaft 2 and inner surface of the sleeve 4. As the carriage 13 has a thickness which is less than the diameter of the bearings 16 it does not come into contact with either the shaft 2 or the sleeve 4 and so does not interfere with movement of the sleeve 4 relative to the shaft 2. As the sleeve 4 rolls against bearings 16 and the bearing slide assembly 12, together with the sleeve 4, rolls against the shaft 2, the friction between the components is considerably reduced.

The pockets 14 formed in the bearing carriage 13 are arranged in four groups 17a, 17b, 17c, 17d. Each group is spaced from its adjacent group in a longitudinal direction or in the direction of movement of the sleeve 4 relative to the shaft 2 and each group is joined by a connecting web 18 having apertures 19 therebetween.

The pockets 14 of each group 17a, 17b, 17c, 17d are spaced from each other across the width of the carriage member 13 or in a circumferential direction once the carriage member 13 has been folded into its generally arcuate form. The material of the carriage member 13 exhibits a region 20 of reduced wall thickness between the pockets 14 of each group to allow the carriage member 13 to flex and deform more easily in these regions so that it can assume the arcuate or tubular shape as illustrated in FIG. 3. The regions 20 of reduced thickness can be seen most clearly in the top plan view of FIG. 5.

FIG. 5 also shows a space 21 between the longitudinal edges 22 of the bearing carriage member 13 when it has been folded so as to assume a generally arcuate shape and the sleeve 4 is provided with a longitudinally extending lip or protruberance (not shown) on its inner surface which fits within this space when the bearing slide member 12 is received between the shaft 2 and the sleeve 4. To prevent the bearing slide member 12 from sliding off the end of the shaft within the sleeve 4, the end of the shaft 2 held within the sleeve 4 has a top cap 23 attached thereto (see FIG. 2). The lip or protruberance on the inner surface of the sleeve 4 slideably locates within a notch or recess (not shown) formed in the top cap 23 to prevent the shaft 2 from rotating relative to the sleeve 4. It will be appreciated that the lip also prevents rotation of the bearing carriage member 13 relative to either the sleeve 4 or the shaft 2.

As is mentioned above, the weight of a monitor attached to the sleeve 4 and the force of the compressed gas strut 5 counterbalance each other so that the sleeve 4 can be slid relative to the shaft 2 into a desired position and released without any need for a clamping mechanism. However, in order to enable the monitor support post to be used with monitors having different weights, it is desirable to provide means for increasing the frictional force between the shaft 2 and the sleeve 4. This is achieved by mounting a friction adjustment mechanism 24 to the lower end of the sleeve 4.

As can be seen most clearly from FIGS. 6A to 6C, the friction adjustment mechanism 24 comprises a generally flexible circular collar 25 for attachment to the lower end of the sleeve 4 using a locking ring 26 illustrated in FIG. 7A and 7B. The collar 25 has four arcuately shaped friction surfaces 27 for engagement with the surface of the shaft 2. Each friction surface 27 is spaced from its adjacent friction surface 27 by a region of reduced wall thickness 28, except that the collar is broken between two friction surfaces 27a, 27b to form facing surfaces 29. These surfaces 29 are held together by a friction adjustment element 30 comprising a threaded shaft 31 having a head 32 immovably received in a recess 33 in the collar 25 and a nut 34 threadingly engaged with the shaft 31 and immovably received within a control knob 35 so that rotation of the knob 35 drives the nut further onto or off the threaded shaft 31. A spring 36 is disposed between the nut 34 and the collar 25 to enable the user to make fine adjustments to the pressure applied to the shaft 2 by the friction surfaces 27 as a result of tightening the knob 35.

The locking ring 26 comprises a circular body 36 having a pair of downwardly extending resiliently flexible arms 37 with lateral protrusions 38 formed on their free ends. During assembly, the arms 37 are passed through the regions of reduced wall thickness 28 of the collar 25 and compressed towards each other so that the protrusions may be slid within the end of the sleeve 4 and located in apertures 39 formed adjacent to the end of the sleeve 4 to mount the collar 25 to the sleeve 4.

Many modifications and variations of the invention falling within the terms of the following claims will be apparent to those skilled in the art and the foregoing description should be regarded as a description of the preferred embodiments only.

1. A telescopic monitor support post comprising a shaft and a sleeve slideable over the shaft against the force provided by a gas strut mounted within and extending between the shaft and the sleeve, wherein a bearing slide assembly is disposed between the shaft and the sleeve and is configured to slide relative to both the shaft and the sleeve during movement of the sleeve relative to the shaft.

2. A telescopic monitor support post according to claim 1, wherein an outer surface of the shaft and inner surface of the sleeve comprise bearing surfaces, the bearing slide assembly cooperating with said bearing surfaces during movement of the sleeve relative to the shaft.

3. A telescopic monitor support post according to claim 2, wherein the bearing slide assembly comprises a bearing carriage member having a plurality of individually spaced pockets, each pocket being adapted to receive and rotatably capture a bearing therein so that a portion of the bearing protrudes from either side of the bearing carriage member for cooperation with the bearing surfaces of the shaft and sleeve.

4. A telescopic monitor support post according to claim 3, wherein the bearing carriage member is formed from a sheet of flexible material shaped to fit within the space between the shaft and the sleeve.

5. A telescopic monitor support post according to claim 3, wherein the sheet comprises separate groups of pockets, each group being spaced from an adjacent group in a direction of movement of the sleeve relative to the shaft.

6. A telescopic monitor support post according to claim 4, wherein the pockets of each group are separated from each other in a direction substantially at right angles to the direction of movement of the sleeve relative to the shaft.

7. A telescopic monitor support according to claim 6, wherein the sleeve and shaft have a circular cross section and the pockets of each group are separated from each other in a circumferential direction.

8. A telescopic monitor support according to claim 6, wherein the pockets of each group are separated from each other by a region of reduced wall thickness to increase the flexibility of the bearing carriage member in said region relative to the remainder of the bearing carriage member.

9. A telescopic monitor support post according to claim 7, wherein each group of pockets is joined by elongate joining portions with spaces therebetween.

10. A telescopic monitor support according to claim 4, wherein the sleeve includes a longitudinally extending protrusion upstanding from its bearing surface towards the shaft and the shaft has a cooperating member thereon which slideably cooperates with the protrusion to prevent the shaft from rotating relative to the sleeve.

11. A telescopic monitor support according to claim 10, wherein the bearing carriage member has longitudinal edges which are brought towards each other when shaped to locate it between the shaft and the sleeve, the protrusion on the sleeve locating between said edges when the bearing carriage member is located between the shaft and the sleeve.

12. A telescopic monitor support according to claim 1, comprising a friction adjustment mechanism to enable a user to control the degree of friction between the shaft and the sleeve.

13. A telescopic monitor support according to claim 12, wherein the friction adjustment mechanism comprises a flexible collar mounted on an end of the sleeve having a plurality of spaced friction surfaces for engagement with the bearing surface of the shaft.

14. A telescopic monitor support according to claim 13, wherein the collar has a break to form two facing end surfaces with a friction control member extending therethrough to control the pressure of the friction surfaces against the bearing surface of the shaft.

15. A telescopic monitor support post according to claim 14, wherein the friction control member comprises a captive bolt extending through the facing end surfaces which carries a spring and a nut, the nut being rotatable relative to the bolt to change the tension in the spring and thereby control pressure applied to the bearing surface of the shaft by the friction surfaces.

16. A telescopic monitor support post according to claim 12, wherein at least some of the friction surfaces are separated by regions of reduced wall thickness to increase the flexibility of the collar.

17. A telescopic monitor support post according to claim 12, comprising a locking ring to attach the collar to the sleeve, the collar comprising a pair of resiliently flexible downwardly extending arms that pass through the collar, each arm having a laterally extending lug on its free end which engages in a corresponding opening in the sleeve.

18. A telescopic monitor support post according to clam 1, wherein a support arm for supporting a monitor is slideably received on the sleeve, the monitor support post comprising a lockable clamping ring which is slideable on the sleeve when released to enable the height of a support arm to be adjusted relative to the sleeve in addition to enabling movement of the sleeve relative the shaft.
